(19) United States
(12) Patent Application Publication
(10) Pub. No.: US 2007/0202952 A1
(43) Pub. Date: Aug. 30, 2007

(54) Trading Card Games And Methods Of Play

(75) Inventors: Kjersti Francis, Wayzata, MN (US); Patricia Henderson, Wayzata, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Stonelore Expeditions, LLC, Wayzata, MN (US)

(21) Appl. No.: 11/576,038

(22) PCT Filed: Sep. 27, 2005
(86) PCT No.: PCT/US05/34317

§ 371 Date: Mar. 26, 2007

Related U.S. Application Data
(60) Provisional application No. 60/613,287, filed on Sep. 27, 2004.

(51) Int. Cl. A63F 1/00; A63F 13/00

(52) U.S. Cl. 463/42; 273/293; 463/43

(57) ABSTRACT

Trading card games and methods of play. The trading card game includes first and second game components comprising a plurality of first and second individual game pieces each having attributes visibly displayed thereon. The second game pieces further including at least one attribute variable during game play. In the preferred methods of game play, the at least one variable attribute includes a point value attribute. The numerical value of the variable point value attribute may increase or decrease during game play. As the variable point value attribute increases in value other attributes of the game pieces may become available for use during game play.

### CROSS REFERENCE TO RELATED APPLICATIONS

This application claims the benefit of, and priority to, U.S. Provisional Application No. 60/613,287 filed Sep. 27, 2004, which is hereby incorporated by reference in its entirety including all appendices thereto.

### BACKGROUND OF THE INVENTION

Trading card games such as Magic The Gathering, Pokémon, Yu-Gi-Oh and the like, are well known in the art. The basic game mechanics of some of the foregoing trading card games are disclosed in U.S. Pat. No. RE 37,957 to Garfield (hereinafter “Garfield '957”).

While the foregoing trading card games serve their intended purpose, there is a need to provide a trading card game which allows players the ability to modify game features or functionalities before, during and/or after game play, in order to enhance the game play experience.

### SUMMARY OF THE INVENTION

The present invention is directed to trading card games and methods of play. In the preferred embodiment, the trading card game includes first and second game components comprising a plurality of first and second individual game pieces each having attributes visibly displayed thereon. The second game pieces further including at least one attribute variable during game play. In the preferred methods of game play, the variable attribute includes a point value attribute. The value of the variable point value attribute associated with a particular game piece may be increased or decreased before, during or after game play. Furthermore, in a preferred embodiment, as the variable point value attribute increases in value other attributes of the game pieces may become available for use during game play.

In a preferred embodiment, the second game pieces preferably include a read/writable data storage medium which cooperates with a reader/writer for reading and writing the variable point value attribute thereto.

### BRIEF DESCRIPTION OF THE DRAWINGS

FIG. 1 illustrates the preferred game components for use in the preferred method of game play of the trading card game of the present invention.

FIG. 2 illustrates a preferred embodiment of the game board for use in the preferred method of game play.

FIGS. 3-5 illustrate embodiments of a first set of game pieces for use in the preferred method of game play of the trading card game of the present invention.

FIG. 6 illustrates an embodiment of a second set of game pieces for use in the preferred method of game play of the trading card game of the present invention.

FIG. 7 illustrates an example of the data that may be stored on the data storage medium of a Shard.

FIGS. 8-10 illustrates alternative game components for use in the preferred method of game play of the trading card game of the present invention.

FIGS. 11-13 illustrate an embodiment of a software graphic user interface and/or a website for use in connection with the game of the present invention.

### DETAILED DESCRIPTION OF THE INVENTION

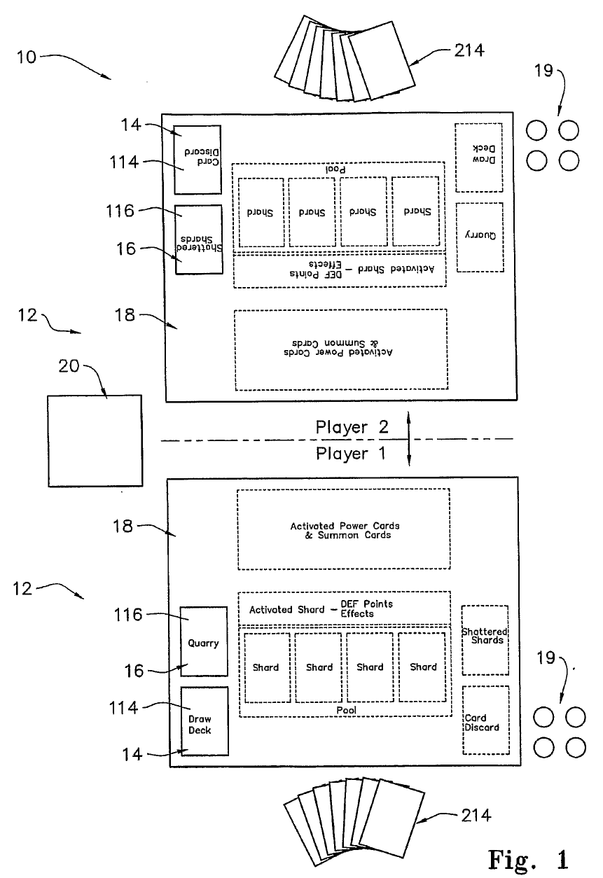

Referring to the drawings wherein like reference numerals designate identical or corresponding parts or features throughout the several drawing figures, FIG. 1 illustrates one embodiment of the trading card game of the present invention designated generally by reference numeral 10.

In the preferred embodiment, the game 10 comprises various game components 12, including a first set of game pieces 14, a second set of game pieces 16, a game board 18, duration markers 19, and a reader/writer 20. Since the preferred method of game play requires at least two players, FIG. 1 illustrates two sets of preferred game components 12, one for each player, but, as shown, only one reader/writer 20 is employed in the game for use by both players. Of course, the game 10 may be played with more than two players, in which event, a single reader/writer 20 may be placed in a central location for access by all players, but with each player preferably having his or her own other game components 12. In alternative embodiments described later, the game and method of play may be played with a remote player or players, such as via the Internet, in which event some of the game components 12 may be “virtual” and some of the game components 12 may be real or physical. Similarly, the opposing player(s) may be another individual (local or remote) or the opposing player(s) may be designated as the computer running the game software.

It should also be understood, that although the preferred embodiment of the game 10 of the present invention and the preferred methods of play (described later) incorporate and utilize all of the above-identified game components, certain game components may be omitted or not utilized or additional game components may be added. Thus, the trading card game of the present invention and its method of play should not be construed as being limited to the specific embodiments and methods of play specifically described herein.

As with currently available trading card games, the game components 12 all preferably correspond to a particular “theme.” For purposes of this disclosure and for illustration purposes only, the “theme” for the preferred embodiment of the game 10 is a mystical Egyptian theme. It should be understood that although the game components are described and illustrated throughout the remainder of this specification and in the drawing figures based on a mystical Egyptian theme, the present invention should not be construed as being limited to the embodiments shown in the drawing figures or to any particular theme.

The first and second sets of game pieces 14, 16 may take any desired form. In the preferred embodiment, the first set of game pieces 14 comprises a plurality of hand-holdable cards similar to the type used in the above referenced trading cards games and/or as disclosed in Garfield '957. Hereinafter, each of the plurality of individual cards comprising the preferred embodiment of the first set of game pieces 14 will be referred to hereinafter as “Challenge Cards.” It should be understood that the terms “Challenge Cards” and “first set of game pieces” have the same meaning and are useable interchangeably.

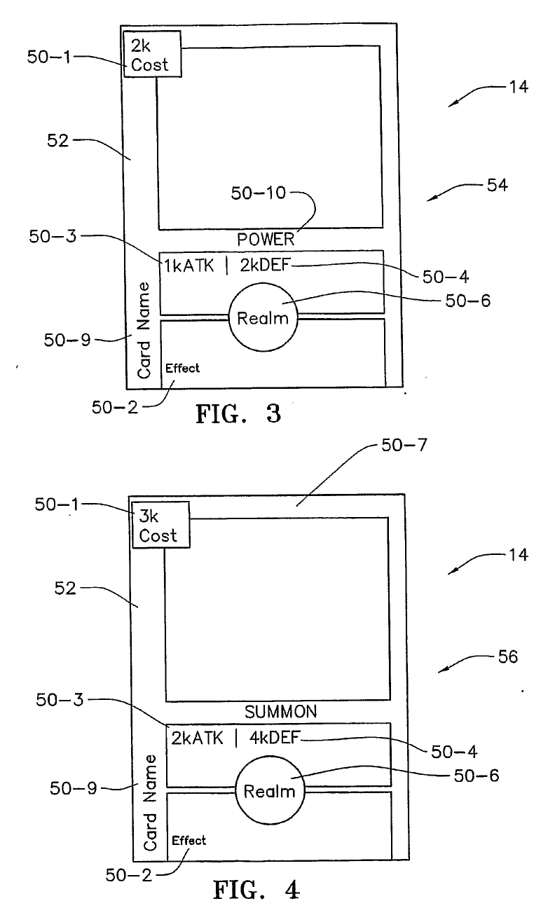

Examples of preferred embodiments of the Challenge Cards 14 are illustrated in FIGS. 3, 4 and 5. Each Challenge Card 14 is preferably constructed of sturdy card stock and preferably includes a theme face (not shown) and an attribute face 52. The theme face preferably includes the name of the game and associated artwork or images corresponding to the game theme. The theme face conceals the attribute face 52 from the opposing player until the Challenge Card 14 is entered into game play. The attribute face 52 preferably includes an illustration corresponding to the game theme and identifies the various attributes 50 associated with the Challenge Card 14 which are relevant to game play.

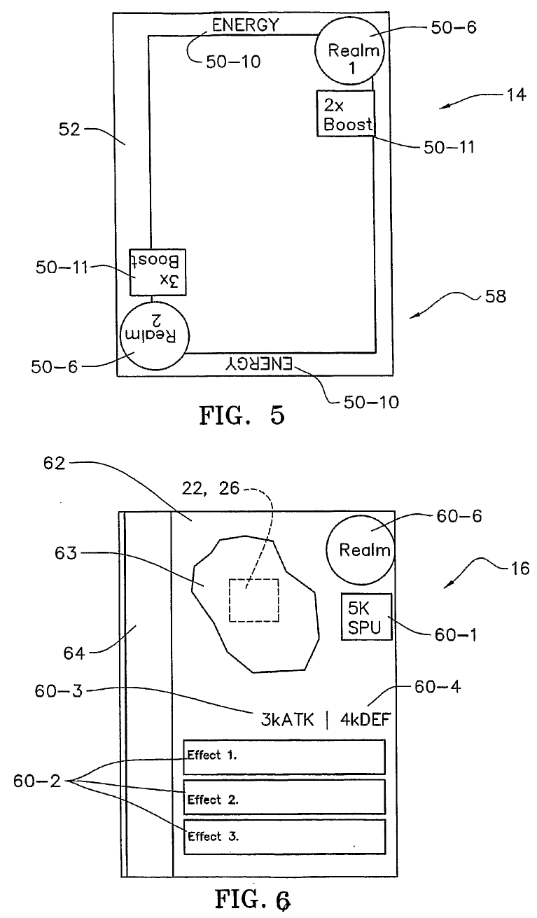

As illustrated in FIGS. 3, 4 and 5, in the preferred embodiment, there are three different types of Challenge Cards 14, namely Power Cards 54 (FIG. 3), Summons Cards 56 (FIG. 4), and Energy Cards 58 (FIG. 5). In the preferred embodiment, each of the three types of Challenge Cards preferably includes one or more of the following attributes 50 unless otherwise identified: (i) a “casting cost” attribute 50-1 (Power Cards 54 and Summons Cards 56 only); (ii) one or more “Effect” attributes 50-2; (iii) the available attack point value (“ATK Points”) 50-3 (Power Cards 54 and Summons Cards 56 only);

(iv) the available defense point value (“DEF Points”) 50-4 (Power Cards 54 and Summons Cards 56 only); (v) a “realm” attribute 50-6; (vi) a duration attribute 50-8 identifying the number of turns a Challenge Card 14 may remain in play during a game; (vii) a name attribute 50-9; (viii) a type attribute 50-10 (i.e., Power Card 54, a Summon Card 56 or an Energy Card 58); and (ix) an energy booster attribute 50-11 (Energy Cards 58 only). The use of Power Cards 54, Summon Cards 56 and Energy Cards 58 in game play, and the use of the attributes associated therewith, will be discussed later under the heading “Basic Game Mechanics.”

As used herein, the term “casting cost attribute” simply refers to the cost associated with bringing the Challenge Card into game play. The casting cost is typically associated with a numerical point value on the card, but may be any other suitable reference identifying a value, point system, rarity, etc. for the Challenge Card.

As used herein, the term “Effect attribute” simply refers to some identified “power” or “ability” of the game piece to have an effect on a game piece or another player's actions during the game or on the manner of playing the game.

As used herein, the term “realm attribute” simply refers to some feature or characteristic, used to identify one of several predefined categories to which the game piece. In the preferred embodiment, the game 10 includes four realms or categories of Cards. The realm attribute may be a symbol, color and/or some other defining characteristic or feature. In the preferred embodiment, Energy Cards 58 have two realm attributes.

The second set of game pieces 16 also preferably comprise a plurality of hand-holdable cards. Following with the assumed mystical Egyptian theme, and for the purpose of distinguishing between the first and second set of game pieces 14, 16, each of the second set of game pieces 16 will be referred to hereinafter as a “Shard,” intending to refer to a fragment of a fictitious ancient Egyptian artifact. It should be appreciated that the terms “Shard” and “second set of game pieces” have the same meaning and are useable interchangeably.

An example of a preferred embodiment of a Shard 16 of the present invention is illustrated in FIG. 6. Each Shard 16 preferably includes a plurality of attributes 60 relevant to game play displayed on an attribute face 62 of the Shard 16. In following with the assumed mystical Egyptian theme, disposed on the attribute face 62 is preferably a small object 63 having the appearance of a fragment or “shard” of an Egyptian artifact. The artifact shard 63 is preferably attached to a piece of card stock 64 having the appearance of an archeological record onto which is cataloged information about the artifact shard 63. To enhance the appearance that the Shard 16 is an ancient Egyptian artifact so as to further carry the mystical Egyptian theme of the game, the artifact shard 63 and card 64 are enclosed within a transparent plastic case 66 in order to protect the “valuable” artifact shard within.

In addition, in the preferred embodiment, each Shard 16 includes a data storage medium 22 for electronically and/or magnetically storing or encoding one or more of the Shard's associated attributes 60. As will be discussed in greater detail later, in the preferred embodiment, certain of these stored or encoded attributes 60 are preferably changeable or writable before, during or after game play.

The attributes 60 associated with a Shard 16 may include one or more of the following: (i) the Shard's base or default Shard Point Units (SPU's) 60-1; (ii) the Shard's Effect attributes 60-2; (iii) the Shard's available attack point value (“ATK Points”) 60-3 (if any); (iv) the Shard's available defense point value (“DEF Points”) 60-4 (if any); and (v) a the Shard's realm attribute 60-6. The use of the Shard 16 in game play and the attributes associated therewith will be discussed later under the heading “Basic Game Mechanics.”

The Challenge Cards 14 and/or Shards 16 are preferably produced in varying quantities such that within the reservoir of available game components 12 in circulation to which players have access, certain Challenge Cards 14 and certain Shards 16 are preferably more rare than others. For example, Shards 16 or Challenge Cards 14 having the most desirable attributes 50, 60 (i.e., higher SPUs or ATK Points or DEF Points or particular Effects) may be more rare than those with less desirable attributes 50, 60. Thus, a feature of the game 10 is the collectability of the Challenge Cards 14 and/or Shards 16. As will become evident later, players who have amassed a greater quantity of rarer game components 12 in his/her “library” from which to choose for playing the game, will have advantages over an opponent who has fewer and/or more common game components 12 in his/her “library” from which to choose to play the game.

Players may collect game components 12 for compiling their library from various sources, including, by purchase from merchants, by gift, by trade, or by winning from other players. All of these sources of game components 12 comprise the “reservoir” to which players have access in order to form their personal library of game components 12.

Prior to players engaging in game play, each player chooses from his/her library a predetermined number of Challenge Cards 14 (hereinafter referred to as the “Draw Deck” 114) and a predetermined number of Shards 16 (hereinafter referred to as the “Quarry 116”) with which to play the game. In the preferred method of play, each player's Draw Deck 114 comprises a minimum of forty five Cards 14 and each player's Quarry 116 comprises a minimum of seven Shards 16. The players may decide to increase or decrease the number of Challenge Cards 14 and Shards 16 comprising each players Draw Deck 114 and Quarry 116, but each player should have the same number of Challenge Cards 14 and Shards 16 for playing the game. However, each player gets to secretly choose which Challenge Cards 14 and which Shards 16 he/she will use for the game. Neither player will know what Challenge Cards 14 or Shards 16 comprise his/her opponent's Draw Deck 14 and Quarry 116 until the Cards 14 and Shards 16 are played during the course of the game. Hence, strategy is required in carefully selecting the Challenge Cards 14 and Shards 16 from one's library to comprise one's Draw Deck 114 and one's Quarry 116 in order to achieve the maximum advantage over his/her opponent's secret Draw Deck 114 and Quarry 116. It should be understood that a player's Draw Deck and Quarry may constitute the player's entire “library” of game components 12.

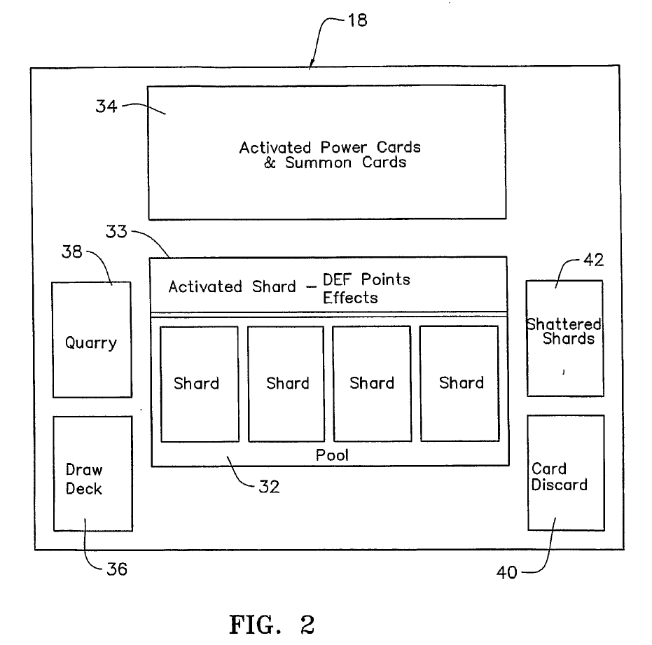

FIG. 2 illustrates an embodiment of a game board 18 for use in playing the game 10 of the present invention. The game board 18 preferably includes a Shard Pool 32 within which a preferred maximum of four Shards 16 at any one time may be placed during game play. The game board 18 also preferably includes an Active Shard Area 33 into which Shards 16 from the Shard Pool 32 are moved to indicate that an Effect attribute 60-2 or DEF Points 60-4 of the Shard 16 is in play. The game board 18 also preferably includes an Active Card Area 34 within which Challenge Cards 14 are placed that are in-play. The game board 18 also preferably includes a Draw Deck Area 36 and a Quarry Area 38. The Draw Deck Area 36 is where the player places his/her preselected Draw Deck 114. The Quarry Area 38 is where the player places his/her preselected Quarry 116. The board 18 also preferably includes a Card Discard Area 40 and a Shattered Shard Area 42, the purposes of which will be also be discussed later. As previously stated, although use of the game board 18 is preferred, in that it helps the players more easily identify which game components 12 are in-play and which are discarded or not in use, it should be understood that the game 10 may be played without the use of a game board 18.

Basic Game Mechanics

In the preferred method of game play, two or more players engage in “duels” by which each player uses his/her respective pre-selected Draw Deck 114 and Quarry 116 to attack and defend against his/her opponent's pre-selected Draw Deck 114 and Quarry 116. The player that forces his/her opponent(s) to discard all the Cards 14 comprising his/her/their Draw Deck 114, is the winner.

As previously identified, a player's Draw Deck 114 will comprise the ratio of Power Cards 54, Summons Cards 56 and/or Energy Cards 58 having the attributes 50 that the player believes will afford him/her the greatest advantage over his/her opponent when used in conjunction with the attributes 60 of the Shards 16 comprising his/her selected Quarry 116.

The preferred method of game play is hereinafter described, it being understood, however, that many modifications are possible without materially departing from the novel teachings and advantages of the basic game mechanics hereinafter described. Accordingly, the scope of the claimed apparatus and methods of game play should not be construed as being limited to the specific embodiments of the apparatus and game mechanics as hereinafter described. To begin, each player places his/her game board 18 (if being used) in front of himself/herself (see FIG. 1). Each player then preferably shuffles her/her pre-selected Draw Deck 114 and Quarry 116. Each player then draws the top Shard 16 from his her Quarry 116 and places it into the Shard Pool Area 32 on his/her respective game board 18 (if being used). Each player then draws and holds a predefined number of Challenge Cards 14 (for example seven) from his/her respective Draw Deck 114. The drawn Challenge Cards 14 will comprise the player's “Card Hand” 214. In the preferred method of game play under the basic game mechanics, the player who's Shard 16 in the Shard Pool Area 32 with the highest SPU attribute 60-1 gets to execute the first turn of the game.

A player's turn will generally comprise executing one or more of the following phases, each of which can comprise one or more actions, steps or procedures as described below: (I) Recharge Phase; (II) Challenge Phase; and (III) Resolution Phase.

I. Recharge Phase: The recharge phase may comprise any one or more of the following actions:
Recharging Drained Shards 16 and Summons Cards 56—At the beginning of each player's turn, the player may “recharge” all his/her “drained” Shards 16 and “multi-duration” Challenge Cards 14. A “drained” Shard or Card simply refers to a Shard or Card that has been turned face-down (i.e., attribute-face 52, 62 down) during the course of a duel indicating that its attributes 50, 60 are no-longer available to the player for the remainder of the duel or any subsequent duel until being “recharged.”
Preferably drained Cards and Shards can only be recharged at the beginning of a player's turn during the Recharge Phase of that players turn. Thus, once a player commences the Challenge Phase of his/her turn, no Shards or Cards may be recharged until the player's next turn.
In the preferred method of game play, as described below, a Shard may become permanently drained such that it is not rechargeable. During the Recharge Phase of a player's turn, permanently drained Shards are removed from game play and placed in the Shattered Shard Area 42.
In the preferred method of game play, Energy Booster Cards 58 and single-duration Power Cards 54 and single-duration Summon Cards 56 (i.e., Power Cards and Summon Cards that do not have duration attributes 50-8) are not rechargeable, as such Cards are preferably only used once by a player during a game. Similarly, once all of the “durations” (discussed later) of a multi-duration Power Card or Summon Card 56 have been used, it cannot be recharged again. As discussed later, to keep track of how many durations a multi-duration Power or Summon Card 54, 56 has been used, “Duration Markers” 19 may be used. Thus, during the Recharge Phase of a player's turn, any Cards 14 that cannot be recharged, are removed from game play and placed in the Card Discard Area 40.
Shard Activation—Shard activation comprises the step of drawing the top Shard 16 from the player's Quarry 116 and placing it face up in that player's Shard Pool 32. Preferably, only one Shard 16 may be activated by a player during a turn. In the preferred method of game play, a maximum of four shards 16 can be active at one time.
Refilling the Card Hand—During the Recharge Phase, a player may refill his Card Hand 214 up to a predetermined maximum number (e.g., seven in the preferred method of game play) by drawing the applicable number of Challenge Cards 14 from the top of a player's Draw Deck 114. In the preferred method of game play, refilling the Card Hand 214 is only permitted during the Recharge Phase of the player's turn. Once a player commences the Challenge Phase, he/she may not refill his/her Card Hand until his/her next turn. In theory, all of the Challenge Cards 14 in a player's Card Hand 214 may be used up during the player's turn or as a result of defending against “attacks” (defined later) from other players, thereby leaving the player with no Cards 14 in his/her Card Hand 214 with which to use in defending against subsequent attacks until it is again that player's turn, at which time he/she is permitted to refill his/her Card Hand 214 during the Recharge Phase of his/her turn.
Shattering a Shard—A Shard is said to be “shattered” when it is voluntarily taken out of game play by a player or forced out of game play by being permanently drained. A player may voluntarily shatter no more than one Shard 16 during his/her turn only during the Recharge Phase. Once a player commences the Challenge Phase, he/she may not elect to voluntarily shatter a Shard. To shatter a Shard, the Shard 16 is moved from the Shard Pool 32 and placed in the Shattered Shard Area 42. If a Shard has been shattered it may be replaced by performing the step of Shard Activation, but, as previously identified, preferably only one Shard may be activated by a player during his/her turn and preferably only during the Recharge Phase of that player's turn.
As identified above, as a result of defending against Attacks, a player may be forced to shatter multiple Shards in his/her Shard Pool. In theory, all of a player's Shards in his/her Shard Pool 32 may end up Shattered in defending against attacks or when attacking, thereby leaving the player with no Shard's in his/her Shard Pool Area 32 with which to use in defending against subsequent attacks until it is again that player's turn, at which time he/she is permitted to activate one Shard during the Recharge Phase of his/her turn.
For example, a player's Shard 16 may be forced to be permanently drained as a result of defending against an attack when the Attacker plays a Power Card 54 having an Effect attribute 50-2 which states that any Shard used against it in defending against an attack requires the Shard to be permanently drained. Alternatively, as another example, a Shard may be permanently drained by the player playing a Power Card 54 having an Effect attribute 50-2 which states that any Shard used to pay the Power Card's casting cost 50-1 is to be permanently drained.

II. Challenge Phase: During the Challenge Phase a player may execute one or more offensive actions as well as one or more defensive actions as follows:

A. Offensive Actions:
Attacking: During the Challenge Phase of a player's turn, the player may “attack” his/her opponent as many times as desired. To execute an attack, the attacking player (hereinafter, “the Attacker”) may use: (a) the Shards 16 from within the Attacker's Shard Pool 32; (b) the Challenge Cards 14 that are in the Attacker's Card Hand 214; or (c) the Challenge Cards 14 that are in the Attacker's Active Card Area 34.
The goal of an Attacker is to inflict as much “damage” as possible during the Attacker's turn against the defending player (hereinafter, “the Defender”). Damage is inflicted if the total attacking point value (TAPV) of the Attacker's Cards and Shards used for a duel (hereinafter, the “Attacking Game Pieces”) is greater than the total defending point value (TDPV) of the Defender's Cards and Shards used for a duel (hereinafter, the “Defending Game Pieces”).
In the preferred method of game play, an attack may be either a “General Attack” or a “Targeted Attack.” As the name implies, a Targeted Attack is an attack executed against a “Target” (i.e., one of the Defender's Challenge Cards 14). In the preferred method of game play, Shard's and Challenge Cards may be the subject of a Targeted Attack. To indicate a Targeted Attack, the attacking Shard 16 and the Targeted card are turned sideways. A General Attack is any attack that is not a Targeted Attack.
An Attack, whether a Targeted Attack or a General Attack, may be made using any of the following single or game piece combinations:
(i) a single Shard 16;
(ii) a single activated Power Card 54;
(iii) a single activated Summon Card 56;
(iv) a Shard with an “Attached” Energy Booster Card 58;
(v) a Shard with one or more Attached Power Cards 54 with or without an Attached Energy Booster Card 58 per Attached Power Card 54;
(vi) a Shard with one or more Attached Summon Cards 56 with or without an Attached Energy Booster Card 58 per Attached Summon Card 56;
(vii) a Power Card 54 with an Attached Energy Booster Card 58 with or without an Attached Shard 16;
(viii) a Summon Card 56 with an Attached Energy Booster Card 58 with or without an Attached Shard 16.
Only one Shard 16 at a time may be used in an attack. If a Shard 16 is being used for an attack, only one of the Shard's attributes 60 may be used in the attack, i.e., an Attacker cannot combine multiple attributes 60 from single Shard 16. The Attacker must specify which of the Shard's attributes 60 are being used for an attack, i.e., the Shard's SPUs 60-1, the Shard's ATK Points 60-3 (if any), or one of the Shard's Effect attributes 60-2 (if any).
Use of any one of the Shard's attributes 60, with the exception of an Effect Attribute 62, for an attack will “drain” the Shard, whereby the Shard's 16 attribute face 52 is turned down on the player's board 18. A drained Shard cannot be used again until it is recharged during the Recharge Phase of the player's next turn.
As identified above, rather than using a Shard 16 to attack, the Attacker may elect to use a Power Card 54 or a Summon Card 56 for an attack. The available attributes 50 of a Power Card 54 or Summon Card 56 for Attacking include the Card's ATK Points 50-3, or any Effect Attributes 50-2. Preferably an Attacker cannot combine multiple attributes 50 from a single Challenge Card 54 or a single Summons Card 56 to attack. Preferably, the Attacker must specify which of the Card's attributes 50 are being used for an attack, i.e., the Chard's ATK Points 50-3 (if any), or one of the Card's Effect attributes 50-2 (if any).
As identified above, an Attacker may elect to attach one or more Challenge Cards 14 from his/her Active Card Area 32 or Card Hand 214 to an attacking Shard or to another attacking Power Card 54 or Summons Card 56, in order to increase the TAPV of the attacking game pieces and/or to decrease the TDPV available to the defending game pieces of a Defender and/or to apply an Effect Attribute 50-2, 60-2. In the preferred method of game play, only one Effect attribute 50-2, 60-2 may be used in an attack regardless of the number of game pieces 14, 16 that are attached by an Attacker for an attack.
In the preferred method of game play, Challenge Cards 14 can only be attached to a Shard 16 if the realm attribute 50-6 of the Challenge Card 14 matches the realm attribute 60-6 of the Shard 16. If a Challenge Card 14 to be attached to the attacking Shard 16 is already activated and in the Active Card Area 34, the activated Card 14 to be attached is flipped over so its attribute-face 52 is down thereby indicating that the Challenge Card is otherwise out of game play. If the activated Card 14 to be attached is a multi-duration Summon Card 56 appropriate duration markers are used to indicate the number of durations the multi-duration Summon Card 56 may remain in play before having to be discarded into the Card Discard Area 42.
If, the Challenge Card 14 to be attached to the attacking Shard 16 is not already activated and is drawn from the Attacker's Card Hand 214, then the non-active Challenge Card 14 must first be activated by paying its casting cost 50-1 so that it can be placed in the Active Card Area 34 (if a Power Card 54 or Summon Card 56) or otherwise made available for use for attaching (as in the case of a Energy Booster Card 58, for example). The casting cost 50-1 of a Challenge Card can only be paid by draining the SPUs 60-1 of a Shard 16 having the same realm attribute 60-6 as the realm attribute 50-6 of the Challenge Card to be activated. Once a Shard 16 is used to pay the casting cost 50-1 of a Challenge Card, the Shard 16 must be flipped upside down to indicate that it is Drained. The drained Shard 16 cannot be used again until it is recharged by the player during the Recharge Phase of the player's next turn.
For example, an Attacker may elect to attach an Energy Booster Card 58 to the attacking Shard 16 to boost the Shard's SPU's 60-1 or ATK points 60-3 to produce a higher attack point value available for the attack. In the preferred method of play, in order to attach the Energy Booster Card 58 to the attacking Shard 16, the realm attribute 50-6 of the Energy Booster Card 58 must match the realm attribute 60-6 of the attacking Shard 16. In the preferred method of game play, Energy Booster Cards 58 preferably have two different realm attributes 50-6 so that the Energy Booster Card 58 is attachable to Shards and Cards 14 from more than one realm. Also in the preferred method of game play, if an Energy Booster Card 58 is attached to a Shard 16 or another Challenge Card 14, the Energy Booster Card 58 is tucked under the Shard 16 or Card 14 to which it is to be attached.
In another example, to further increase the attack point value available for attacking an opponent's Challenge Card(s) 14 the Attacker may activate an Effect attribute 50-2, 60-2 of the Shard 16 or any Challenge Cards 16 which has the effect of increasing the SPUs and/or ATK Points of the attacking Shard 16 or the attacking Challenge Card 14 or to an attached Shard or Card, as the case may be.
To indicate that an Effect attribute 60-2 of a Shard 16 is activated, the Shard 16 is moved forward from the Pool 32 into the Activated Shard Area 33. To indicate that an Effect Attribute 50-2 of a Challenge Card 14 is activated, the Challenge Card 14 is placed in the Activated Card area 34. As previously identified, no matter how many Cards 14 are being used in an attack, with or without a Shard 16, only one Effect Attribute 50-2, 60-2 may be activated at a time in a single attack.
When an Attacker initiates an attack against an opposing player, whether a Targeted Attack or a General Attack, that opposing player must immediately defend against the attack using only the Shards 16 in his/her Shard Pool 32, and/or the Challenge Cards 14 in his/her Card Hand 214 or in the Active Card Area 34 of the player's board.
A player's turn is not over at the end of any single duel. Rather, the Attacking player may engage in multiple duels during his/her turn with play going back and forth between Attacker and Defender during each duel. A player's turn will continue until the player desires to end his/her turn by entering into the “Reconcile Phase.” After the Reconcile Phase of a players turn is over, it is the next player's turn.
Defending Against an attack: In response to a General Attack, the Defender may use, either alone or in combination, and in any order of combination he/she chooses, any single Shard 16 from the Defender's Shard Pool 32 and/or any one or more Challenge Cards 14 from the Defender's Active Card Area 34 or from the Defender's Card Hand 214 (subject to paying the casting-cost of the Card 14 to be Activated) to absorb the attack.
A Shard 16 can absorb an attack using its SPUs 60-1 or DEF Points 60-4, or any single Effect Attribute 60-2. A single Shard's SPUs and DEF Points cannot be added together when calculating the TDPV. The Defender must choose to use one or the other when calculating the TDPV for defending against an attack. A defending Shard's SPUs 60-1 or DEF Points 60-4 can be “boosted,” however, by attaching an Energy Booster Card 58 to the defending Shard. In order to attach an Energy Booster Card 58, one of its the realm attributes 50-6 must match the realm attribute 60-6 of the Shard 16. When the SPUs 60-1 or DEF Points 60-4 of a Shard are used to defend against an attack, the Shard is deemed completely drained and must be turned face-down, even if all the Shard's available SPUs or DEF Points were not needed to absorb the attack. The Shard 16 must remain flipped face-down and cannot be used for any purpose until it is Recharged during the Recharge Phase of the player's turn.

A Power Card 54 or a Summon Card 56 can absorb an attack using its DEF Points 50-4 (if any). A Power Card's or Summon Card's DEF Points (if any) can be “boosted” by attaching an Energy Booster Card 58. In order to attach an Energy Booster Card 58 to a Power Card 54 or a Summon Card 56, the realm attributes 50-6 of the Energy Booster Card 58 must match the realm attribute 50-6 of the Power Card 54 or Summon Card 56 to which it is to attach. A Defender can play any number of Power Cards 54, Summon Cards 56 and attached Booster Cards 58, one after another to absorb an attack. However, the Defender must play his Cards 54, 56 starting with the Card with the lowest DEF Points 50-4 first, then the Card with the next lowest DEF Points, and so-on, until either the attack is absorbed or the Defender chooses to stop dueling. If the attack is a Targeted Attack, the Targeted Card 54, 56 must be used first in defending against the Targeted Attack. Note, Shards 16 and Energy Booster Cards 58 cannot be the subject of a Targeted Attack. In addition to using DEF Points of a Card 54, 56 to absorb an attack, the effects of any Effect attributes 50-2 can be taken into account. Only one Effect attribute 50-2 can be used at a time.
Use of Duration Markers: Associated with some, but not necessarily all, Summon Cards is a duration attribute 50-8 which identifies how many turns the Summon Card 56 may be used by a player before it must be taken out of play by moving it to the Card Discard Area 40. To enable players to more easily keep track of the number of turns a multi-duration Summon Card has been used during game play, duration markers 19 are preferably used.
For example, assume a Summon Card 56 has a duration attribute 50-8 indicating that the Summon Card 56 and its associated attributes 50 may be used for two turns by the player whether attacking or defending. Under this example, two duration markers 19 will be placed on the Summon Card 56 when it is activated (i.e. when its casting cost 50-1 is paid) and placed in the Active Card Area 34 of the player's board 18. If the player elects to use the Activated Summon Card 56 to attack an opponent or to defend against an attack, one duration marker 19 is removed, thereby indicating that the summoned creature has only one life or duration remaining with which to attack or defend. After using the Summon Card to defend or attack a second time, the second duration marker is removed. During the Recharge Phase of the player's next move the twice-used Summon Card is removed from game play by moving it to the Card Discard Area 40 like any other single duration Challenge Card 14.

B. Defensive Actions.
Preparing to Defend Against an Attack: As previously identified, a player can only Refill his/her Card Hand and activate Shards during the Recharge Phase at the beginning of that player's turn. Thus, strategy is involved in not leaving oneself vulnerable to excessive damage when play paces to the next player, whereby instead of being an Attacker the player will be placed in the position of being a Defender.

III. Resolution Phase: The resolution phase is where damage (if any) is assessed and where any activated Effect Attributes 50-2, 60-2 of any Cards 14 and Shards 16 played during a duel are taken into account.
Damage Assessment. If a Defender suffers damage in defending against an attack, the player suffering damage must remove from his/her Draw Deck 114 and put into his/her Card Discard Area 38, the number of Challenge Cards 14 that correspond to the damage suffered, thereby reducing the number of cards 14 available to the player for the remainder of game play. If an attack has been absorbed, no damage is incurred.
For example if a Defender loses a duel by defending against an attack wherein the total attack point value of the Attacker's attacking game pieces totals 5000 or 5 k and the total defense point value of the Defender's defending game pieces totals 3000 or 3 k, then the Defender will suffer damage of 2 k (i.e. 5 k−3 k=2 k). The Defender must then remove two Challenge Cards 14 from his/her Draw Deck 114 and place them in his/her Card Discard Area 38.
   Enhanced Game Mechanics

With the foregoing basic game mechanics described, the enhanced game mechanics for a preferred method of game play are hereinafter presented. Under the enhanced game mechanics, the players are preferably provided with the ability to vary or alter one or more of the attributes 50, 60 of the Challenge Cards 14 and/or Shards 16 during game play. One method of enabling players to alter the attributes 50, 60 is to utilize a reader/writer 20 as previously briefly identified to interface with the read/writable data storage medium 22, also previously briefly identified, for reading and writing data to and from the Shards 16 in order to vary or alter one or more attributes 50, 60 associated with the Card 14 or Shard 16. The use of a data storage media 22 and a reader/writer 20 makes it easier for players to keep track of the modified attributes, but it should be understood that players may engage in the enhanced method of game play by keeping track of the modified attributes with paper and pencil as opposed to employing electronic tools as described in more detail below.

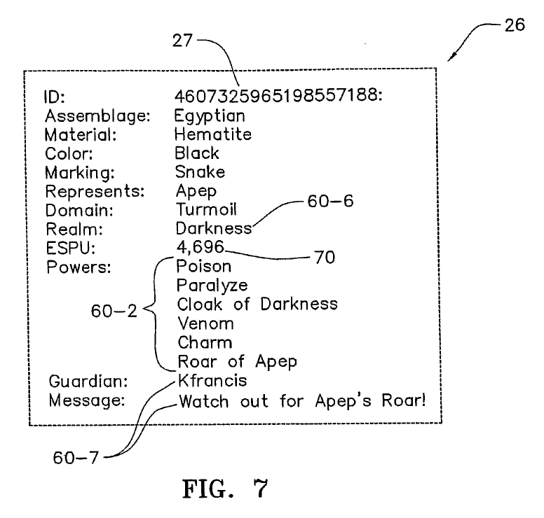

In the preferred embodiment, as previously identified, each Shard 16 includes a data storage medium 22. The data storage medium 22 may be any suitable storage medium, including magnetic or optical. An example of the attributes that may be stored or encoded on the data storage medium is illustrated in FIG. 7. In addition to the attributes each Shard 16 also has a unique identifier 27 (FIG. 7) encoded on the data storage medium 22 for identifying the Shard and its associated attributes when being scanned or otherwise communicating or interfacing therewith during game play (discussed later). With respect to the Effect attributes 60-2, in the preferred embodiment, each Shard preferably has multiple Effect attributes 60-2 each of which may become active upon the Shard reaching a certain point value as described in detail later. Other information that may be stored on the data storage medium 22, including personalized attributes 60-7 such as the Shard owner's or guardian's name or a personalized message.

In the preferred embodiment, the Challenge Cards 14 preferably do not include a data storage medium 22 for price considerations and because, under the preferred method of game play, the desired ability to modify the attributes of both the Challenge Cards 14 and the Shards 16 can be accomplished with the Shards only. It should be understood, however, that the game 10 of present invention or any of its various methods of game play, does not preclude or disclaim the use of a data storage medium 22 in the Challenge Cards.

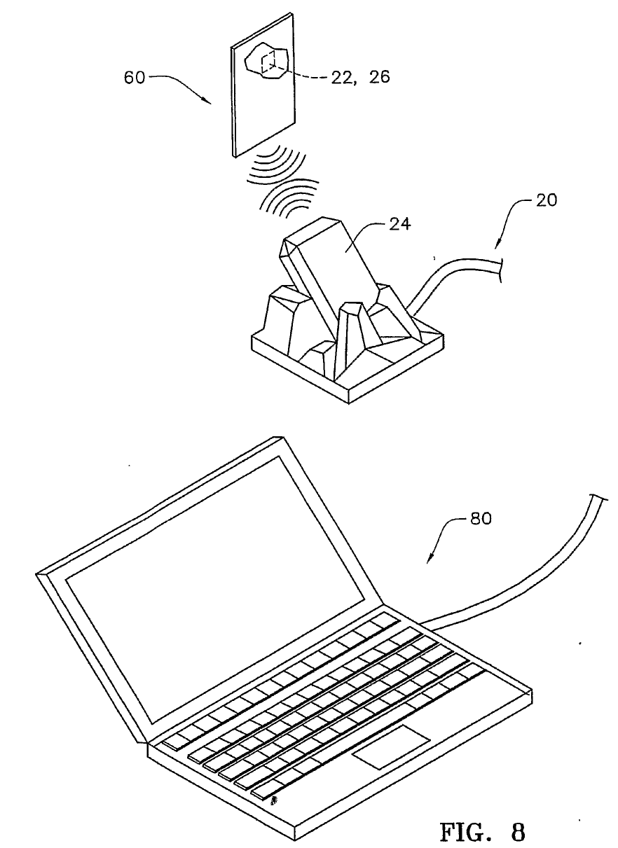

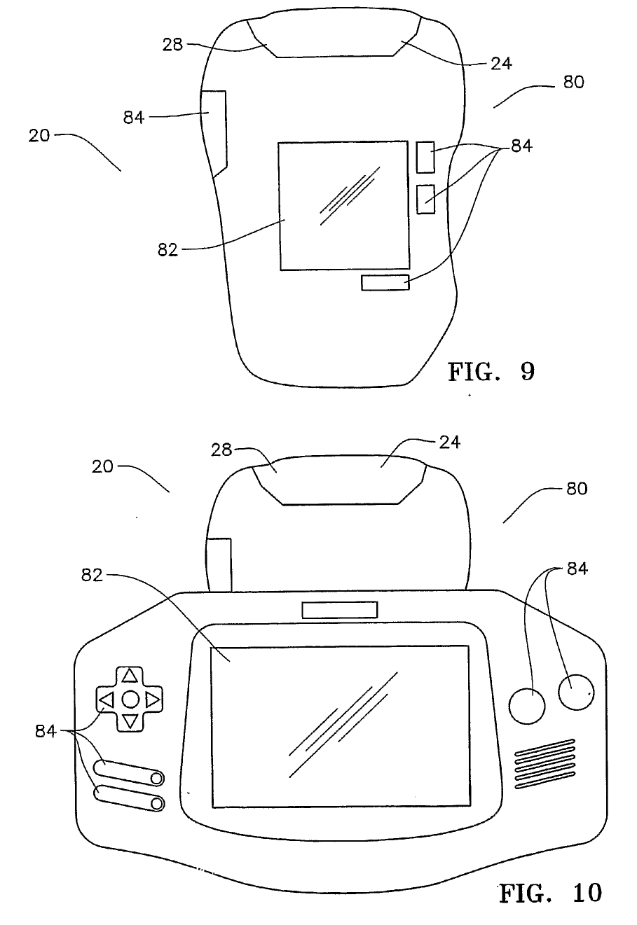

In the preferred embodiment, the reader/writer 20 includes a data transfer interface 24 that preferably provides or enables the capability of both reading from the data storage medium 22 as well as writing to the data storage medium 22 during game play, i.e. “read/write” capability. Following with the Egyptian theme, in the preferred embodiment, the data transfer interface 24 is embodied in a “Portal Crystal” which connects to a computer 80 having a display 82 and a user interface 84. Appropriate software and drivers are provided to enable the attributes 60 to be read from the data storage medium 22 when the Shards are “scanned” by the Portal Crystal. The attributes associated with the scanned Shard are preferably displayed on the computer display 82 such that the Shard's attributes 60 are visibly displayed to the players. In addition, the software preferably cooperates with the computer hardware to sort and store into memory for later retrieval, each Shard's unique identifier 27 and its associated attributes 60. The software also preferably permits the players to select different game options including the ability to modify the attributes and to write or rewrite the modified attributes back to the same Shard or a different Shard as described in more detail later. As illustrated in FIGS. 8 and 9, instead of a Portal Crystal, the data transfer interface 24 may be embodied in a portable handheld computing device, such as a Palm Pilot™ or GameBoy® or other electronic computing device.

In the preferred embodiment, the data transfer interface 24 is preferably a contact-less interface which communicates with the Shard, for reading and writing data thereto and therefrom simply by bringing the Shard into proximity with the reader/writer interface 24. Other types of contact or contact-less interfaces may also be employed depending on the data storage medium 22 employed. For example, if the data storage medium 22 is a magnetically encodeable magnetic strip such as typically found on the backs of credit cards and other types of financial cards, then the interface 24 and reader/writer 20 may be the may be similar to the magnetic stripe reader/writer apparatus disclosed, for example, in U.S. Pat. No. 5,748,737, which is hereby incorporated by reference in its entirety, including all references cited therein. Alternatively, if the data storage medium 22 is a “smart chip” or other integrated circuit, the data transfer interface 24 may be a contact or contact-less interface such as the types also disclosed in U.S. Pat. No. 5,748,737. Suitable contact-less type data transfer interfaces may include any technology involving the transmission of data through, or using any portion of, the electromagnetic wave spectrum.

The preferred contact-less type data transfer interface 24 is a RF interface comprising a transceiver 28 which produces an electromagnetic energy field. The integrated circuit 22 of the Shard 16 preferably includes a transponder or “tag” 26 which, when brought into proximity with the data transfer interface 24 is powered by the electromagnetic field produced by the transceiver 28 and effecting read/write data communication between the transponder tag of the integrated circuit 26 and the transceiver 28. An example where this type of technology is currently being used is in the packaging and shipping industries where radio frequency identification (RFID) is being used to augment or replace bar-code identification. Those of ordinary skill in the art of electronic data transfer would readily appreciate the necessary hardware and software required to provide the foregoing functionality to the game apparatus of the present invention and its methods of play.

Utilizing the preferred RF tag technology in the Shard 16 and providing a transceiver 28 to enable read/write capability with the Shard 16, a preferred method of enhanced game play is hereinafter described which enables players to vary or alter the attributes 60 of the Shards 16 during game play or thereafter.

In one embodiment, each Shard's SPU's 60-1 as identified on the face of the Shard 16 are electronically stored in memory in the integrated circuit 26. These electronically stored SPUs are hereinafter referred to as Electronic Shard Point Units (ESPU's) 70. Initially, the ESPU's 70 may or may not be the same as the SPU's 60-1 displayed on the face of the Shard. As hereinafter described, however, as play progresses, a Shard's ESPU's 70 may be increased or decreased before, during or after game play.

For example, one method of enhanced game play enables players to choose to play a “realm-based” game. Upon selecting a realm-based game, the reader/writer 20 is preferably programmed to randomly select and display a chosen realm. All Shards 16 within that chosen realm are preferably allocated, for example, an additional 1000 point units (+1 k) to the their ESPU's 70, whereas all Shards 16 of the other realms have 1000 point units (−1 k) subtracted from the Shard's ESPU's 70. The ESPU's 70 are preferably automatically added or subtracted from the player's Shards by the player bringing each of his/her Shards from his/her Quarry 116 into proximity with the reader/writer at the beginning of game play or upon Shard Activation.

Additionally or alternatively, for example, the reader/writer 20 may be programmed to allow players to assign a handicap value based on a players skill level. For example a beginner may have +1 k ESPU's 70 added to each of his/her Shards, whereas an intermediate player may have zero point units (+0 k) added, and an expert may have −1 k subtracted from each of his/her Shard's ESPU's 70. As previously described, the ESPU's 70 may be added or subtracted from the player's Shards by the player bringing each of his/her Shards into proximity with the reader/writer at the beginning of game play or as each Shard is brought into game play before being placed in the Pool 32. Obviously more than three skill levels may be assignable and different ESPU's values or other attributes may be assigned based on skill level.

Additionally or alternatively, for example, the reader/writer 20 may be programmed to allow players to select whether they wish to “bank” ESPU's 70 for awarding to the winner of the game. For example, under this method of game play, the reader/writer 20 is preferably programmed to allow the players to enter the number of players. Each player then in turn, selects one of his/her shards from the Quarry 116 and brings it into proximity with the reader/writer 20. The reader/writer 20 is preprogrammed to subtract a predefined number of ESPU's (for example 0.1 k or 100 point units) from each player's selected Shard. The subtracted ESPU's are then banked by the reader/writer 20 until the end of the game. At the end of the game, the winner presses a preprogrammed button or key on the reader/writer 20 to transfer the banked ESPUs to one of his or her active Shards in the Pool 32 by bringing the selected Shard into proximity therewith.

By adding ESPU's to the Shard 16 by one or more of the foregoing examples, new or additional attributes 60 may be activated upon the Shard's ESPU value reaching higher levels. For example, higher or more powerful effects would be available when a specific threshold of strength or rank is obtained. Referring to FIG. 7, as an example, the “Poison” Effect is available at the Shard's base SPU's 60-1 (i.e. 4,696 SPU's). If, however, the Shard's ESPU's 70 increase by +2 k, for example, then the “Paralize” Effect becomes available for game play. If the Shard's ESPU's increase by +3 k, then the “Cloak of Darkness” Effect is available, etc. Each Effect attribute 60-2 has a different effect on the Challenge Cards with or against which it is played. The description of the Effect may be printed on the Shard or it may be encoded on the data storage medium and displayed on the display 82 upon the Shard being scanned.

Alternative Game Mechanics for Video Game Play:

Instead of playing the game with physical Cards 14 and Shards 16, the game 10 may be a video game, wherein the Cards 14 and Shards 16 are “virtual.” In another embodiment, the Challenge Cards 14 may be virtual but the Shards 16 may be real. In such an embodiment, the players may bring their respective physical Shards into the virtual computer game by scanning their respective Shards 16 using their respective reader/writers 20. In either of the foregoing video-game embodiments, the players may play through the same computer or the players may be remote from one another, playing over a computer network, such as the Internet or an Intranet.

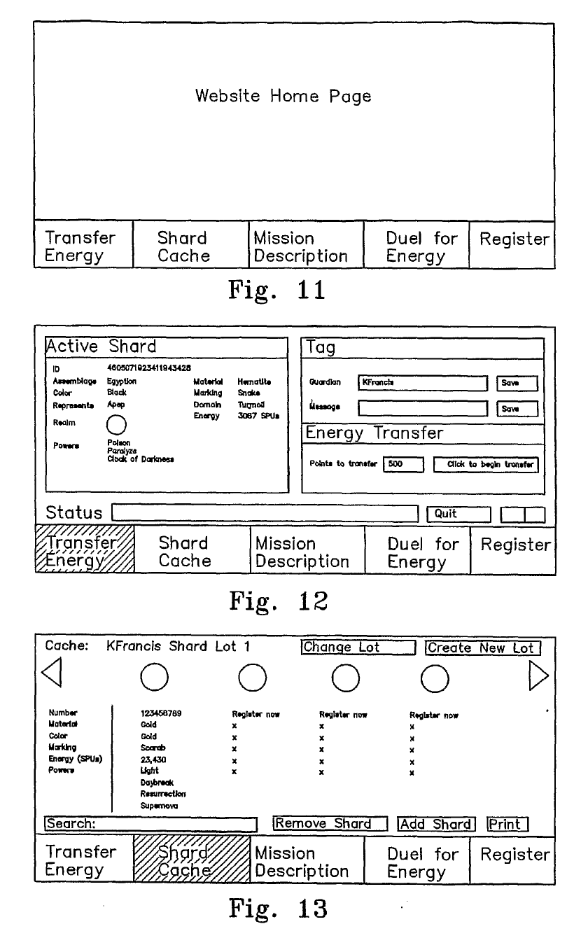

As an example of an Internet or Web-based game, an Internet website may be provided onto which player-subscribers log in and upload their Shard's attributes via an interface with the reader/writer 20. FIGS. 11-13 illustrate an embodiment of a web based game of the present invention. Preferably, the website is programmed such that upon selecting a clickable “Scan” option on the website (FIG. 12), the Shard's attributes 60 are automatically uploaded via the reader/writer 20 connected to the player's computer and cached in the player's on-line Quarry where they are collected, sorted and displayed in association with the subscriber's user name and password (see FIG. 13). The web-based game may be played substantially as described above with the now-scanned virtual Shards.

Through the website, other features and functionalities may be provided. For example, upon a player-subscriber acquiring a particular Shard or upon a player-subscriber achieving a certain threshold ESPU 70 value, the subscriber to be entered into a contest, or be granted access to an otherwise locked area of the website. The player-subscriber may be able to redeem ESPU's 70 from one or more Shards to receive/purchase items or to participate in events, promotions, etc. Alternatively, the subscriber may be able to download via the reader/writer 20 to the Shard 16 new or different attributes, such as additional ESPU's, new Effect attributes 60-2, etc. Additionally, rewards may be given through the website if a subscriber purchases and scans in a new Shard 16, or if the subscriber purchases a reader/writer 20, or other merchandise, or upon acquiring a particular player ranking in an Internet based game, being the first player to open a new area of game play to all Internet players, solving certain puzzles, actively spreading the word about the game to others, etc.

In yet another embodiment of the game and method an interactive computer-based fictional game is provided whereby a player reads text or an audio file is played pertaining to the game. During game play, players may encounter creatures, puzzles, obstacles, locked areas, hidden treasures, and other challenges. The player may interact with the game by clicking or selecting with a mouse or other user interface, a displayed action. By providing a game that allows users to click an action item, the players need not know how to type or spell. Thus, such an embodiment may be played by young children unable to spell.

The game may allows the player to scan in a Shard to, for example, defeat creatures, unlock locked areas, solve puzzles, find treasures and get by obstacles. Different obstacles, creatures, locked areas, etc. require the use of different, specific game piece effects to have an effect. At the end of game play, the player may write the rewards earned during play back onto his or her favorite or desired Shards as previously described to make the those Shards more powerful for future play or to increase its value when traded.

Modified Existing Trading Card Game and Method of Play

In another embodiment of the present invention, a modified version or second generation of an existing trading card game is provided such as Magic the Gathering, Yu-Gi-Oh, etc. The modified game includes the same game components as currently existing in the game, but, in addition, a new set of cards would include a read/writable data storage media such as the type as previously described. This new set of cards would correspond to the Shards 16 and Challenge Cards as previously described for the preferred embodiment of the game of the present invention. Stored or “written” onto the data storage media is preferably at least writable attribute preferably corresponding or otherwise associated with an attribute of an existing game piece. For example, as described in the Garfield '957 patent, a card's “life point” attribute or “power rating” attribute may be stored on the writable data storage media. The modified existing game would further include a reader/writer corresponding to the reader/writer 20 as previously described for interfacing with the modified game to enable the electronically stored attribute to be modified during game play and/or thereafter.

The method of game play for the modified version would preferably follow the same basic game mechanics as the exist game, but would further include the additional game features or mechanics such as previously described above with respect to the preferred embodiment of the game and its method of play of the present invention.

The modified game may simply comprise an enhancement kit comprising the foregoing additional game components sold separately at retail by third parties or by the game's original distributor to end users for modifying previously sold games or games still in inventory. Alternatively, rather than an enhancement kit, as yet another alternative embodiment, an existing game may be repackaged with the foregoing additional game components and sold as a modified version or second generation of the existing trading card game.

Although only certain exemplary embodiments of the game and methods of play of present invention have been described in detail above, those skilled in the art will readily appreciate that many modifications are possible without materially departing from the novel teachings and advantages of this invention. Accordingly, all such modifications are intended to be included within the scope of this invention as defined in the following claims.

1. A game, comprising:
(a) a first set of selected game pieces comprising a predefined quantity of individual first game pieces, each of said individual first game pieces having a plurality of first attributes relevant to game play visibly displayed thereon;
(b) a second set of selected game pieces comprising a predefined quantity of individual second game pieces, each of said individual second game pieces having a plurality of second attributes relevant to game play visibly displayed thereon each of said individual second game pieces further having a variable point value attribute which is stored on a data storage medium on said second game piece;
wherein a relationship exists between certain of said first and second attributes of certain of said individual first and second game pieces, whereby use of certain of said game pieces during game play by a player is dependent upon said relationship.

2. The game of claim 1 wherein said first and second sets of selected game pieces are selected by the player of the game from the player's library of game components, the player's library of game components previously compiled by the player from a reservoir of said first and second individual game pieces wherein said reservoir comprises varying: multiple copies of said first and second individual game pieces.

3. The game of claim 1 wherein another of said first attributes and one of said second attributes includes a realm attribute and wherein said relationship between at least one of said plurality of first and second attributes further includes a relationship between said realm attribute of said individual first game piece desired to be entered into game play and said realm attribute of said individual second game piece desired to be used to bring said individual first game piece into game play.

4. The game of claim 1 wherein one of said plurality of first attributes includes a cost attribute.

5. (canceled)

6. The game of claim 4 wherein said relationship between at least one of said plurality of first and second attributes includes a relationship between said cost attribute of said individual first game piece desired to be entered into game play and said variable point value attribute of said individual second game piece desired to be used to bring said individual first game piece into game play, wherein said variable point value attribute is at least equal to said cost attribute of said first game piece desired to be entered into game play.

7. (canceled)

8. The game of claim 4 further comprising a reader/writer having a data transfer interface for communicating with said data storage medium for reading and writing said variable point value attribute.

9. The game of claim 8 including a display screen and a data input interface for viewing said variable point value attribute and interacting with said individual second game pieces.

10. The game of claim 9 wherein said display screen and said data input interface are incorporated into said reader/writer.

11. The game of claim 9 wherein said display screen and said data input interface are separate from but interface with said reader/writer.

12. The game of claim 8 wherein said data storage medium is an encodeable magnetic strip.

13. The game of claim 12 wherein said reader/writer comprises a magnetic strip reader/writer which, when said encodeable magnetic strip is swiped through said magnetic strip reader/writer, said variable point value attribute is communicated between said data storage medium and said reader/writer,

14. The game of claim 8 wherein each of said individual second game pieces further includes an integrated circuit with a contact interface for communicating data to and from said data storage medium.

15. The game of claim 14 wherein said data transfer interface includes a contact interface mateable with said contact interface of said individual second game pieces which, upon contact therewith, said variable point value attribute is communicated between said data storage medium and said reader/writer.

16. The game of claim 8 wherein each of said individual second game pieces further includes an integrated circuit with a contact-less interface for communicating data to and from said data storage medium.

17. The game of claim 16 wherein said data transfer interface includes a contactless interface which, when in proximity with said individual second game pieces, said variable point value attribute is communicated between said data storage medium and said reader/writer.

18. The game of claim 17 wherein said integrated circuit includes a radio frequency (RF) transponder and said contact-less interface comprises a RF transceiver whereby, when said RF transponder is in proximity with said RF transceiver, said variable point value attribute is communicated between said RF transponder and said RF transceiver.

19. The game of claim 8 wherein different of said second attributes of said individual second game pieces become effective for game play upon said individual second game pieces having written to its variable point value attribute a greater numerical value.

20. A method of game play involving at least two players, the method comprising the steps of:
(a) each player selecting a predefined number of Challenge Cards with which to form the player's Draw Deck and a predefined number of Shards with which to form the player's Quarry, each of said Challenge Cards having Card Attributes relevant to game play visibly displayed thereon, each of said Shards having Shard Attributes relevant to game play visibly displayed thereon, each of said Shards further having at least one variable point value attribute which is stored on a data storage medium on said Shard;
(b) each player drawing a Card Hand comprising a predefined number of said Challenge Cards from said player's respective Draw Deck;
(c) during each players' sequential turn, engaging in duels by which one of said players uses its Challenge Cards and Shards against another of the said players to cause damage to said another of said player's Challenge Cards and Shards;
wherein, during each player's sequential turn, use of at least one of said player's Challenge Cards and Shards is dependent upon a relationship with at least one other of said player's Challenge Cards and Shards.

21. The method of claim 20 wherein one of said Card Attributes and one of said Shard Attributes includes a realm attribute and wherein said relationship between at least one of said Card Attributes and said Shard Attributes includes a relationship between said realm attributes of said Challenge Card desired to be entered into game play and said realm attribute of said Shard desired to be used to bring said Challenge Card into game play.

22. The method of claim 21 wherein another of said Card Attributes includes a cost attribute.

23. (canceled)

24. The method of claim 22 wherein said relationship between at least one of said plurality of Card Attributes and said Shard Attributes includes a relationship between said cost attribute of said Challenge Card desired to be entered into game play and said variable point value attribute of said Shard desired to be used to bring said Challenge Card into game play, wherein said variable point value attribute must be at least equal to said cost attribute of said Challenge Card desired to be entered into game play.

25. (canceled)

26. The method of claim 22 further comprising providing a reader/writer having a data transfer interface for communicating with said data storage medium for reading and writing said variable point value attribute.

27. The method of claim 26 further comprising providing a display screen and a data input interface for viewing said at least one variable point value attribute and interacting with said Shard.

28. The method of claim 27 wherein said display screen and said data input interface are incorporated into said reader/writer.

29. The method of claim 28 wherein said display screen and said data input interface are separate from but interface with said reader/writer.

30. The method of claim 26 wherein said data storage medium is an encodeable magnetic strip.

31. The method of claim 30 wherein said reader/writer comprises a magnetic strip reader/writer which, when said encodeable magnetic strip is swiped through said magnetic strip reader/writer, said variable point value attribute is communicated between said data storage medium and said reader/writer.

32. The method of claim 26 wherein each of said Shards further includes an integrated circuit with a contact interface for communicating data to and from said data storage medium.

33. The method of claim 32 wherein said data transfer interface includes a contact interface mateable with said contact interface of said Shard which, upon contact therewith, said variable point value attribute is communicated between said data storage medium and said reader/writer.

34. The method of claim 26 wherein each of said Shards further includes an integrated circuit with a contact-less interface for communicating data to and from said data storage medium.

35. The method of claim 34 wherein said data transfer interface includes a contactless interface which, when in proximity with said Shard, said variable point value attribute is communicated between said data storage medium and said reader/writer.

36. The method of claim 35 wherein said integrated circuit includes a radio frequency (RF) transponder and said contact-less interface comprises a RF transceiver whereby, when said RF transponder is in proximity with said RF transceiver, said variable point value attribute is communicated between said RF transponder and said RF transceiver.

37. The method of claim 26 wherein different Shard Attributes of said Shard become effective for game play upon said Shard having written to its variable point value attribute a greater numerical value.

38. The method of claim 26 whereupon when said Shard is used to bring a desired Challenge Card into game play, said Shard is turned face-down to indicate it is drained and is unavailable for game play until being recharged by said player upon said player's next turn.

39. The method of claim 38 wherein a players turn includes a recharge phase, a challenge phase and a reconcile phase;
said recharge phase comprising the steps taken from the group comprising: (i) recharging any drained Shards; (ii) shattering a desired Shard; (iii) activating a new Shard from said player's Quarry; and (iv) refilling said player's Card Hand;
said challenge phase includes the step of attacking another of said players' Challenge Cards and Shards;
said reconcile phase including the steps of calculating the amount of damage incurred by said another of said players and, if damage has incurred, discarding a corresponding number of Challenge Cards from said another player's Draw Deck.

40. The method of claim 39 wherein a winner of the game is the one of said players with Challenge Cards remaining in its Draw Deck.

41. The method of claim 40 further comprising the step of:
at the beginning of game play, each of said players banks a predetermined portion of said variable point value attribute of a select one of its Shards, whereafter each player's selected Shard has a variable point value less an amount equal to said predetermined banked portion, whereby a sum of each of said player's predetermined banked portions amounts to a banked point value, and whereupon at the end of game play, the game winner is awarded said banked point value for adding to said variable point value of said winner's selected Shard.

42. The method of claim 40 further comprising the steps of:
choosing a realm for a realm based game;
assigning all said Shards matching said chosen realm an additional predetermined point value and subtracting said predetermined point value from all said Shards not matching said chosen realm.

43. The method of claim 42 wherein said predetermined point values are added and subtracted to said variable point value attribute of each said player's Shards at the beginning of game play.

44. The method of claim 42 wherein said predetermined point values are added and subtracted to said variable point value attribute of each said player's Shards upon Shard Activation.

45. The method of claim 40 further comprising the steps of:
assigning a predetermined handicap value to each players Shards based on a player's skill level;
adding and subtracting said predetermined handicap value based on said player's skill level.
